(19) United States
(12) Patent Application Publication
(10) Pub. No.: US 2013/0175368 A1
(43) Pub. Date: Jul. 11, 2013

(54) Waste Water Diffuser

(71) Applicant: Greberis Stanley, Freehold Township, NJ (US)

(72) Inventor: Greberis Stanley, Freehold Township, NJ (US)

(21) Appl. No.: 13/726,910

(22) Filed: Dec. 26, 2012

Related U.S. Application Data
(60) Provisional application No. 61/584,119, filed on Jan. 6, 2012.

(51) Int. Cl. F17D 1/08

(52) U.S. Cl. CPC F17D 1/08
USPC 239/548

(57) ABSTRACT

This application claims a system for the distribution of waste water. The invention allows water to drain from a source into the invention, where the water is distributed and diffused through a collection of outlets. Thus a large amount of water can be distributed over a large area so that the environment can more easily absorb the water and the flow of water does not cause erosion. The preferred embodiment of the invention includes one or more filters to remove substances from the water before distribution.

### PRIORITY

This application claims the benefit of provisional application No. 61/584,119, that was filed on Jan. 6, 2012 by the inventor Stan Greberis.

### BACKGROUND OF THE INVENTION

The present invention relates to methods and apparatus for handling waste water and, more particularly, to a waste water diffuser that may prevent waste water from causing soil erosion and/or being discharged into a public storm water systems and/or sanitary sewers and/or waterways.

When a person faces a task of getting rid of excess, unwanted water, for example water from a basement sump or water from a pool, the water is typically carried by a hose or pipe to be released. Often, a large release of water may cause soil erosion. To avoid this type of erosion, a person may opt to disburse the water into a public storm water system down their driveway into a street drain and/or a sanitary sewer system. This type of release may be harmful to the environment and may be illegal in many jurisdictions, especially in the case of pool water, which may contain certain chemicals.

As can be seen, there is a need for an apparatus for diffusing and distributing waste water to avoid erosion and the delivery of waste water into inappropriate channels.

### BRIEF DESCRIPTION OF THE DRAWINGS

FIG. 1 is a schematic view of a water distribution system according to an exemplary embodiment of the present invention.

FIG. 2 is a schematic view of the water distribution system according to another exemplary embodiment of the present invention.

FIG. 3 is a detailed view of the interior of the water distribution system.

FIG. 4 is another detailed view of the interior of the water distribution system.

FIG. 5 is another detailed view of the interior of the water distribution system.

FIG. 6 is another detailed view of the interior of the water distribution system.

FIG. 7 is another detailed view of the interior of the water distribution system.

FIG. 8 is a detailed view of the flow of water through the water distribution system.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a water distribution system that may discharge waste water into the surrounding soil without creating soil erosion. The water distribution system may create a fountain-like or sprinkler-like distribution of waste water over a large ground surface area, permitting the water to soak into the soil rather than run over the top of the soil, which leads to erosion.

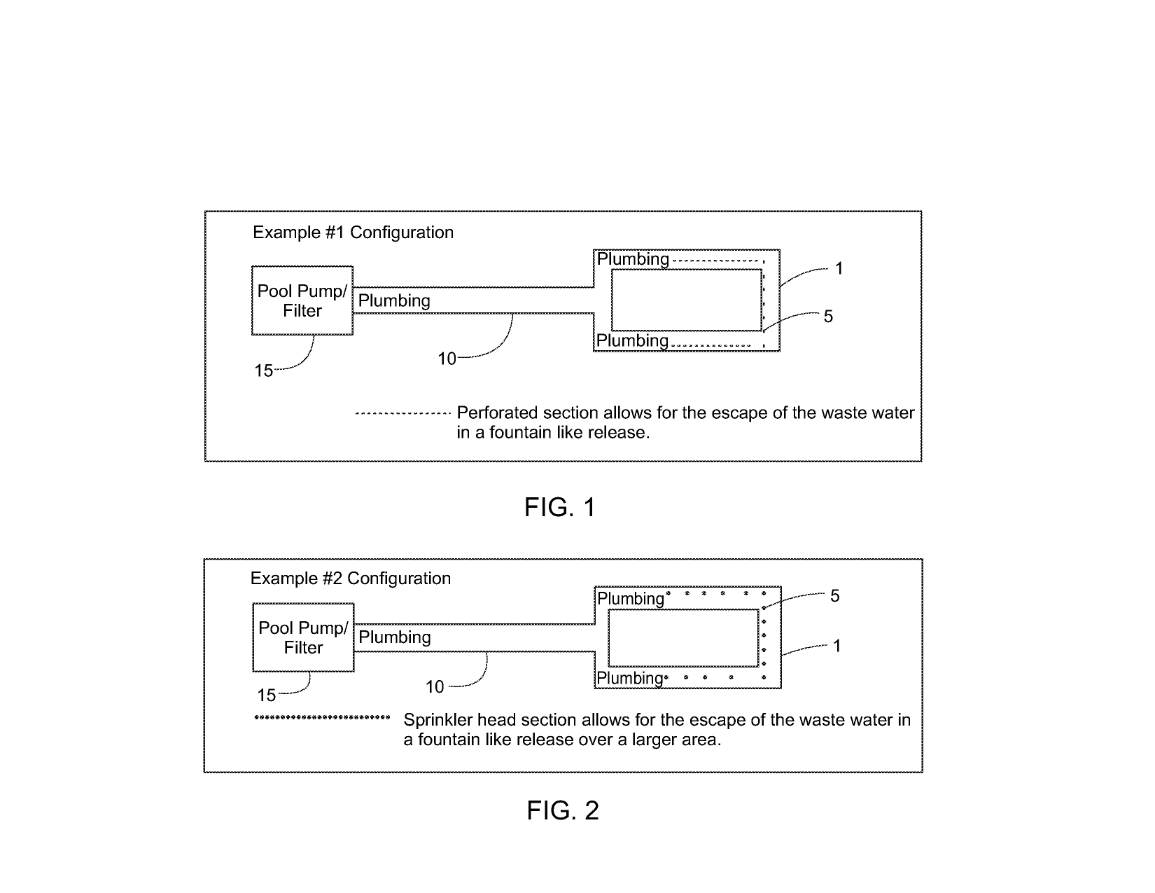

Referring to FIG. 1, a water distribution system may be a fountain-type system where tubing may carry water from a pump, such as a pool water pump, to a series of perforations in the pipe which distribute the water from the tubing in a fountain-like distribution. The perforations may be distributed along the tubing such that there is little or no overlap from the spray from one of the perforations to the spray of an adjacent perforation.

Referring to FIGS. 1 and 2, the water distribution system comprises a pool pump or filter 15 connected to a supply tube 10. The supply tube 10 is connected to a distribution tube 1. On the distribution tube 1 is a plurality of distribution openings 5. FIG. 1 shows the distribution openings 5 as holes. FIG. 2 shows the distribution openings 5 as sprinklers.

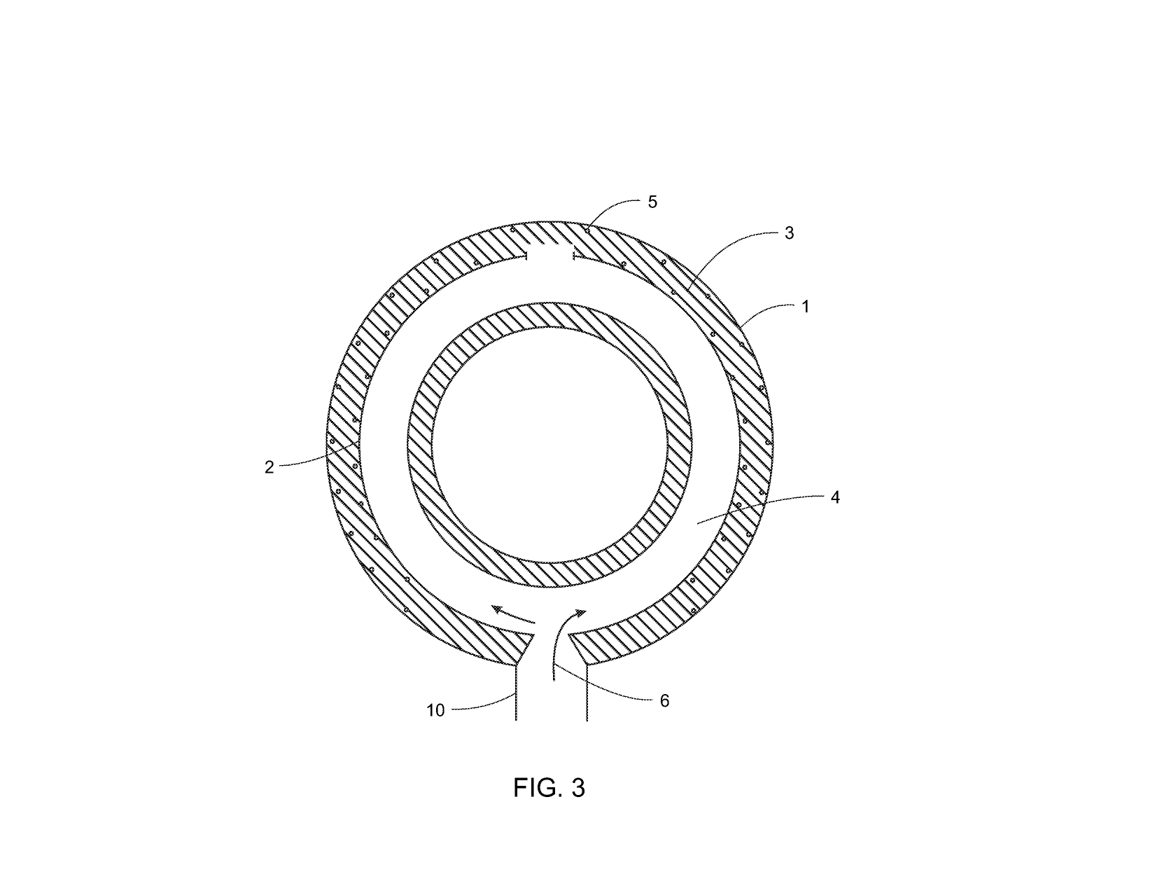

Referring to FIG. 3, FIG. 3 shows a top view of the water distribution system with supply tube 10 connected to and entering distribution tube 1. Supply tube 10 is then inside the distribution lumen 3 of the distribution tube 1, forming inner tube 2. The distribution tube 1 also has distribution openings 5. The water 6 travels in the supply lumen 4 of the supply tube 10, through inner tube 2, then into the distribution lumen 3 of the distribution tube 1. The water 6 is then distributed out of the system by the distribution openings 5.

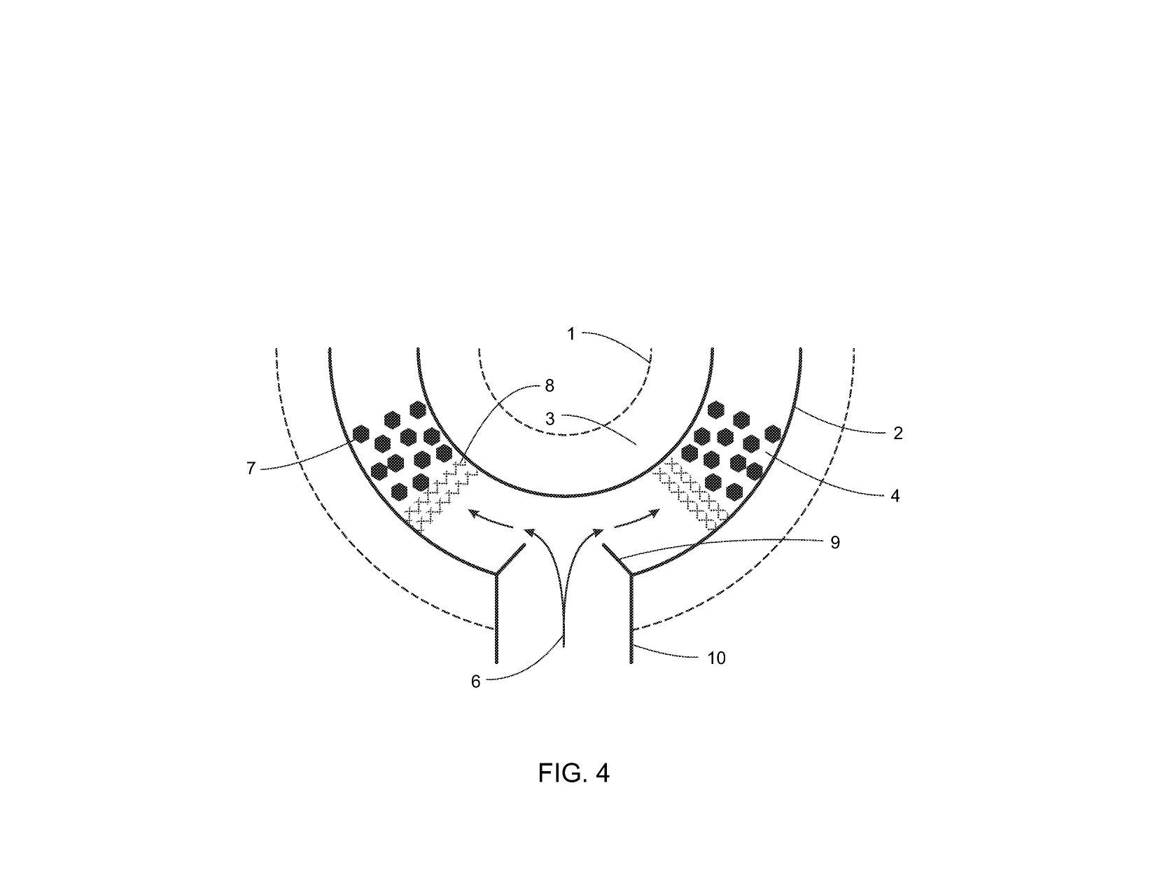

Referring to FIG. 4, FIG. 4 is a detailed drawing of the junction between the supply tube 10 and the distribution tube 1. At the point where supply tube 10 meets distribution tube 1, the two tubes are joined and reinforced by a collar or funnel 9. The funnel 9 creates an opening into the inner tube 2, which is itself an extension of the supply tube 10. The inner tube 2 contains a filter 7 in the supply lumen of the supply tube 10 in the part of the supply tube 10 that is also the inner tube 2. In the preferred embodiment, the filter 7 comprises carbon particles. These filter 7 particles are held in place by a mesh 8. Thus the water 6 can flow from the supply tube 10, past the funnel 9, into the inner tube 2, which is in turn in the distribution lumen 3 of the distribution tube 1.

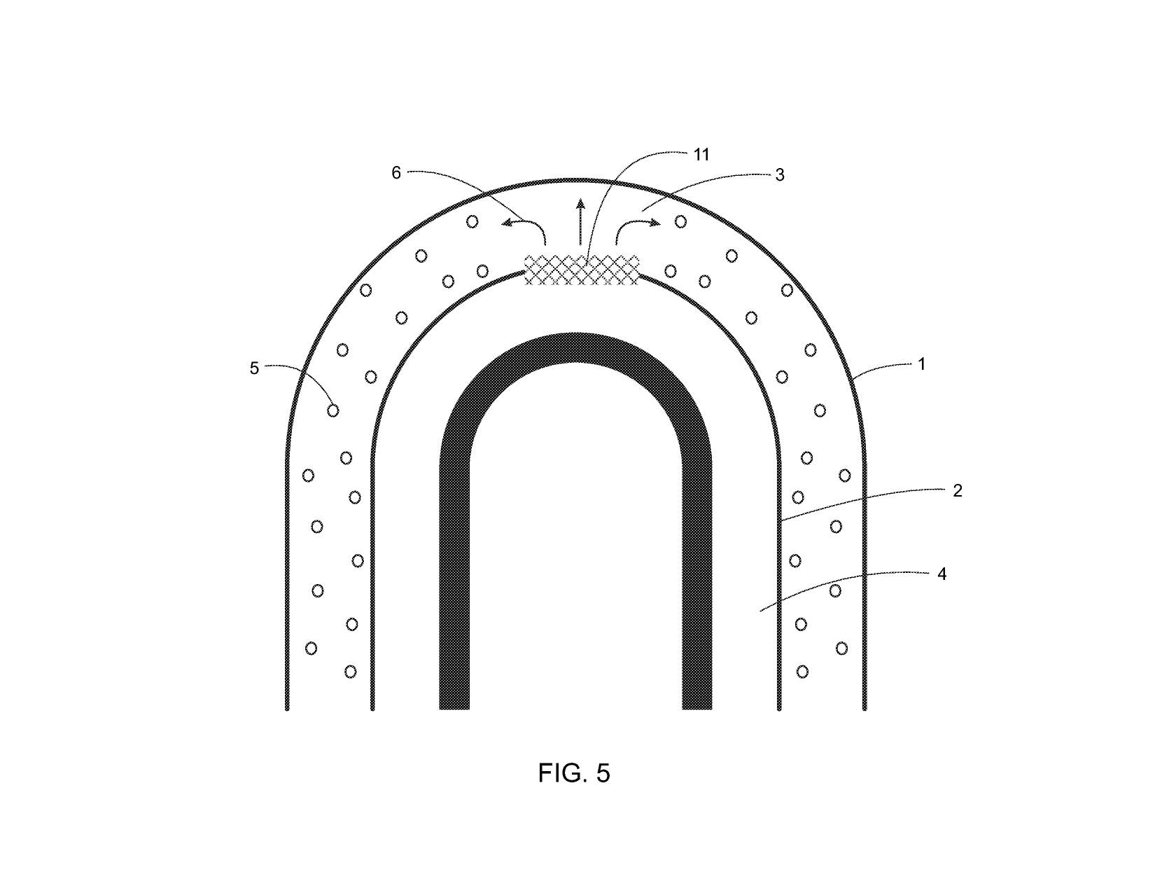

Referring to FIG. 5, FIG. 5 is a detailed drawing of the outlet 11 between the inner tube 2 and the distribution tube 1. Distribution tube 1 has distribution openings 5. Water 6 travels through supply lumen 4 and crosses outlet 11 to enter distribution lumen 3 and then exit distribution tube 1 through distribution openings 5.

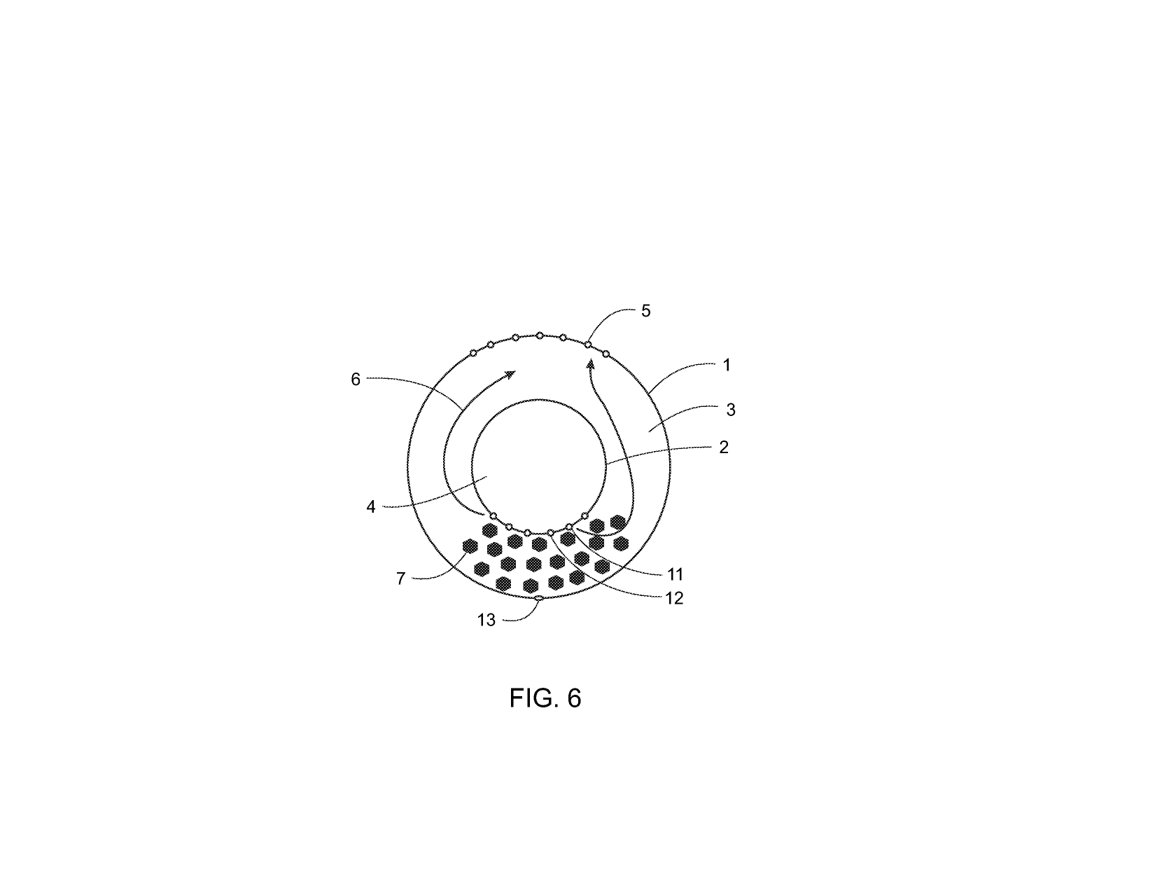

Referring to FIG. 6, FIG. 6 is a cross section of the water distribution system. Distribution tube 1 has distribution lumen 3 and distribution opening 5. Within the distribution lumen 3 is inner tube 2. Inner tube 2 contains supply lumen 4, which is a continuation of the supply tube 10, not pictured. Inner tube 2 has outlet 11. Outlet 11 comprises a plurality of outlet openings 12. Filter 7 is located in distribution lumen 3. Distribution tube 1 also has a drain 13. In this version, the position of outlet 11 and filter 7 is at the bottom of distribution lumen 3, so that water 6 must travel down through outlet 11 and filter 7 and then up to distribution openings 5.

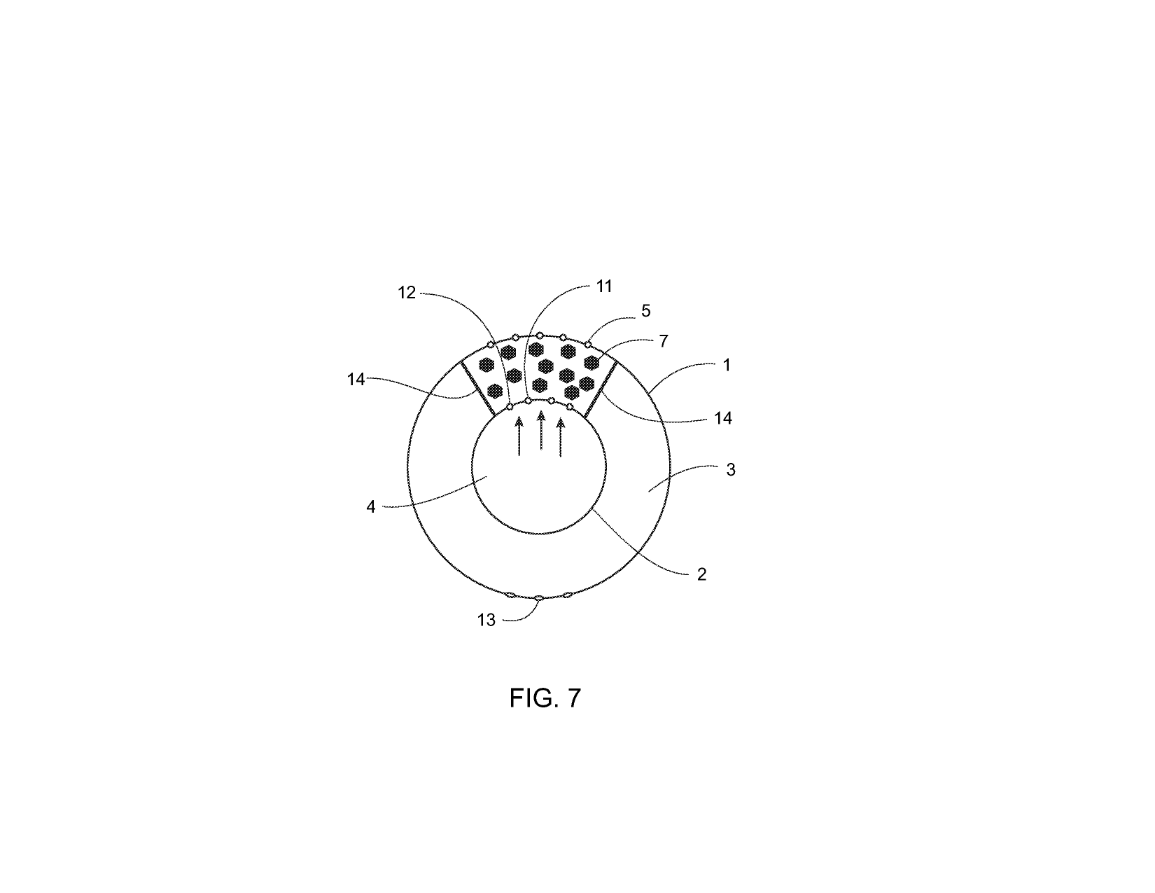

Referring to FIG. 7, FIG. 7 is a cross section of the water distribution system. Distribution tube 1 has distribution lumen 3 and distribution opening 5. Within the distribution lumen 3 is inner tube 2. Inner tube 2 contains supply lumen 4, which is a continuation of the supply tube 10, not pictured. Inner tube 2 has outlet 11. Outlet 11 comprises a plurality of outlet openings 12. Filter 7 is located in distribution lumen 3. Filter 7 is held in place by flanges 14. Distribution tube 1 also has a drain 13. In this version, the position of outlet 11 and filter 7 is at the top of distribution lumen 3, so that water 6 must travel up through outlet 11 and filter 7 and then up to distribution openings 5.

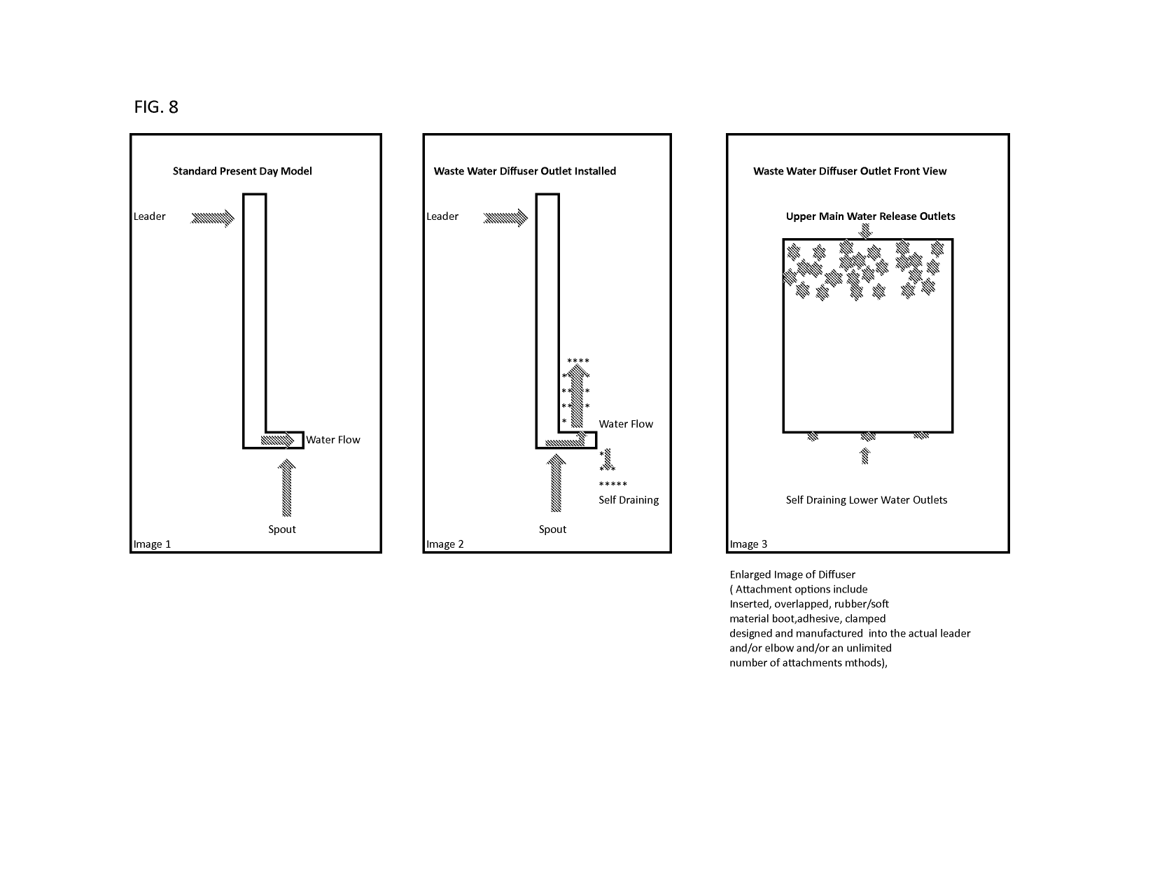

Referring to FIG. 8, FIG. 8 is a detailed view of the flow of water through the water distribution system. FIG. 8 compares the present invention to a hypothetical standard arrangement and shows the flow of water through each system. Image 2 and 3 of the FIG. 8 show a side and front view of the flow of water through the water distribution system.

While FIG. 1 shows a rectangular distribution area, the tubing may be arranged in any number of patterns. The size of the perforations may be determined through a variety of factors, such as the type of soil, the amount of water typically distributed through the system on a single time, the pressure of the water within the tubing during the distribution process, and the like. Typically, the number of perforations and the size thereof will be adequate to distribute/diffuse the waste water while permitting the water to be absorbed into the soil, without causing soil erosion. In the preferred embodiment, the distribution tube will be circular in shape. The circular shape is preferable because it promotes even distribution of the water, and is ascetically pleasing. Other embodiments are also functional and may be advantageous in cases where the desired distribution of water is uneven. Other embodiments of the water distribution system can also be a be a three-dimensional shape, such as a box, pyramid, ball or any other shape that will capture the water and then allow for the escape through the upper and side perforations and/or attachments, such as sprinkler heads, while including a modest amount of perforations on the bottom to allow the unit to self drain. Each of these three-dimensional versions can have a modified bottom so that the water distribution system can be placed stability on a surface, such as making the bottom of a ball flat.

The tubing may be typical plumbing tubing and may include PVC, metal, or other materials. For example, the tubing leading from the waste water source (such as a pool), may be collapsible flexible drain tubing, permitting easy storage thereof. The distribution portion of the tubing may be the same or different material as the tubing connecting the water source (pool) to the distribution portion. In some embodiments, the distribution portion may be rigid tubing, which may ensure alignment of the perforations, or distribution openings 5, perpendicular to the ground.

Referring to FIG. 2, in place of the distribution opening 5, sprinkler heads may be fluidly connected to the distribution tube 1 to permit the waste water 6 to be distributed over a larger surface area.

In some embodiments, the system of the present invention may be supplied as a kit. The kit may include tubing to connect the distribution system to the pump and distribution tubing having a water distributing means, such as perforations or sprinkler heads, as described above. The kit may supply the distribution tubing in various pieces and may include a variety of connectors so that a user may create their own pattern for water distribution. For example, the kit may include various pieces of perforated pipe along with elbows, tees, and the like. The fittings may be quick release fittings, permitting the user to quickly assemble and disassembly the system of the present invention.

The filter 7 may be made of any filtering material, including foams, mesh, ceramics, and absorbent particles. In the preferred embodiment, the filter 7 is made of carbon particles that are larger than any exit to the inner tube 2. In some cases the carbon particles will be held into place by a mesh 8 or a flange 14.

In some embodiments, the distribution tube 1 has one or more drains 13. The drains 13 are placed on the bottom portion of the distribution tube 1. The purpose of the drains 13 is to drain any water trapped or remaining in the distribution tube 1 so that the distribution tube 1 is dry for storage. Furthermore, standing water is a know vector for insect larvae growth. The drains 13 will allow the operator to drain the distribution tube 1 to reduce the growth of insect larvae.

In some embodiments, the filter 7 is external to the distribution tube 1. In this case, the filter 7 is placed before or within supply tube 10 and before the junction between supply tube 10 and distribution tube 1. In other embodiments, the filter 7 is not included in the apparatus. In this embodiment, the water 6 will pass through the distribution tube 1 and inner tube 2 without being filtered.

The preferred embodiment envisions the use of the wastewater drainage system to distribute unneeded pool water. The wastewater drainage system can also be used to drain rain and other runoff water. The wastewater drainage system can be attached to a sink, tube, or tank drain. The wastewater drainage system can be attached to a gutter or downspout. The system can be used in landscaping and construction site applications.

It should be understood, of course, that the foregoing relates to exemplary embodiments of the invention and that modifications may be made without departing from the spirit and scope of the invention as set forth in the following claims.

What is claimed is:

1. A water distribution system comprising:
a supply tube for carrying waste water from a source to a distribution tube; and
a plurality of distribution outlets in the distribution tube, the distribution outlets adapted to distribute the waste water over a surface.

2. The water distribution system of claim 1 where:
the distribution tube is in the form of a circle.

3. The water distribution system of claim 1 where:
the distribution outlets are holes.

4. The water distribution system of claim 1 where:
the distribution outlets are sprinklers.

5. The water distribution system of claim 1 where:
the supply tube extends and travels within the distribution tube and includes an outlet on the supply tube that allows water within the supply tube to leave the supply tube and enter the distribution tube.

6. The water distribution system of claim 1 where:
the supply tube contains a filter.

7. The water distribution system of claim 6 where:
the filter comprises a plurality of carbon particles

8. The water distribution system of claim 5 where:
the supply tube contains a filter.

9. The water distribution system of claim 8 where:
the filter comprises a plurality of carbon particles.

10. The water distribution system of claim 5 where:
the outlet comprises a plurality of openings that are sized to prevent back flow of water from the distribution tube into the supply tube.

11. The water distribution system of claim 7 where:
the carbon particles are of a size that is larger than the openings of the outlet from the supply tube to the distribution tube.

12. The water distribution system of claim 9 where:
the carbon particles are of a size that is larger than the openings of the outlet from the supply tube to the distribution tube.

13. The water distribution system of claim 1 where:
the system does not include a filter.

14. The water distribution system of claim 1 where:
the system includes a filter that is external to the distribution system and is placed between the source of the water and the system so that the water flows through the filter and then into the system.

15. The water distribution system of claim 1 where:
The water distribution system includes one or more openings placed approximately on the bottom of to drain water from the water distribution system prior to storage of the water distribution system.

16. The water distribution system of claim 1 where:
The water distribution system in formed into a three-dimensional shape.

17. The water distribution system of claim 16 where:
The water distribution system is in the shape of a box.

18. The water distribution system of claim 16 where:
The water distribution system is in the shape of a pyramid.

19. The water distribution system of claim 16 where:
The water distribution system is in the shape of a ball.

20. A water distribution system comprising:
a supply tube for carrying waste water from a source to a distribution tube;
wherein the supply tube extends within the distribution tube;
and the supply tube has an outlet with a plurality of openings that allows water to move from the supply to the inside of the distribution tube without back flow of the water into the supply tube;
and the supply tube also contains a filter comprising carbon particles of a size that is larger than the plurality of openings of the outlet from the supply tube to the distribution tube;
and the distribution tube has a plurality of distribution outlets;
and the distribution outlets adapted to distribute the waste water over a surface,
so that water may enter the water distribution system by the supply tube, be filtered by the carbon particles, then enter the distribution tube and leave the distribution tube by the distribution outlets so that the water is distributed and dispersed over an relatively large area.
